(19) United States
(12) Patent Application Publication
(10) Pub. No.: US 2017/0060050 A1
(43) Pub. Date: Mar. 2, 2017

(54) IMAGE FORMING APPARATUS, IMAGE FORMATION SYSTEM AND METHOD OF CONTROLLING HEATING AMOUNT

(71) Applicant: Konica Minolta, Inc., Tokyo (JP)

(72) Inventors: Hajime KAWAKAMI, Tokyo (JP); Shinichi TSUKAMURA, Yamanashi (JP)

(73) Assignee: Konica Minolta, Inc., Tokyo (JP)

(21) Appl. No.: 15/237,060

(22) Filed: Aug. 15, 2016

(30) Foreign Application Priority Data
Sep. 1, 2015 (JP) 2015-172005

(51) Int. Cl. G03G 15/20

(52) U.S. Cl. CPC G03G 15/2039

(57) ABSTRACT

An image forming apparatus includes: a fixing member; a heating section; and a control section, the control section being configured to control the heating section such that, the heating section heats the fixing member with a first heating amount during a period from a first timing until a second timing, and the heating section heats the fixing member with a second heating amount smaller than the first heating amount and greater than 0 during a period from the second timing until a third timing.

### CROSS REFERENCE TO RELATED APPLICATIONS

This application is entitled to and claims the benefit of Japanese Patent Application No. 2015-172005, filed on Sep. 1, 2015, the disclosure of which including the specification, drawings and abstract is incorporated herein by reference in its entirety.

### BACKGROUND OF THE INVENTION

1. Field of the Invention

The present invention relates to an image forming apparatus, an image formation system and a method of controlling a heating amount.

2. Description of Related Art

In general, an electrophotographic image forming apparatus (such as a printer, a copy machine, and a fax machine) is configured to irradiate (expose) a charged photoconductor with (to) laser light based on image data to form an electrostatic latent image on the surface of the photoconductor. The electrostatic latent image is then visualized by supplying toner from a developing device to a photoconductor drum (image carrier) on which the electrostatic latent image is formed, whereby a toner image is formed. Further, the toner image is directly or indirectly transferred to a sheet, and then heat and pressure are applied to the sheet at a fixing nip to form a toner image on the sheet.

In addition, as the fixing section used for the above-mentioned image forming apparatus, a fixing section is known which includes a fixing member (for example, a fixing roller) and a heating source disposed inside the fixing member (for example, a halogenheater). When the inside of the fixing member is heated by the heating source, the heat is transmitted to the surface, and thus a toner image is fixed to a sheet at the fixing nip.

The heat of the fixing member is removed by the fixing nip during the printing job; however, in the case where a printing job for 100 or more sheets is executed for example, when heating is continuously performed by the heating source from the inside during the printing job, the temperature of the inside and the surface is set to a saturated state where no more temperature rise of the inside and the surface is caused. In this case, after the last sheet passes through the fixing nip in the printing job, the removal of heat from the surface of the fixing member does not occur and therefore the internal heat of the fixing member is transmitted with a delay to the surface in the saturated state. Consequently, the surface temperature of the fixing member may be suddenly raised (this phenomenon is hereinafter referred to as “overshooting”).

A technique for reducing the temperature variation due to overshooting is disclosed in Japanese Patent Application Laid-Open No. 2014-191296 for example. In this technique, the output of the heating source is turned off before the last sheet of the printing job passes through the fixing nip. In this manner, the internal temperature of the fixing member decreases after the last sheet passes through the fixing nip, and accordingly the increase in the surface temperature of the fixing member is suppressed, thus reducing the overshooting.

However, in the technique disclosed in Japanese Patent Application Laid-Open No. 2014-191296, when the output of the heating source is turned on in the next job, it becomes necessary to again heat the inside of the fixing member, and consequently the heat transmission from the inside to the surface of the fixing member is delayed, and as a result, the surface temperature of the fixing member is reduced to a temperature lower than that of a normal operation (this phenomenon is hereinafter referred to as “undershooting”). Therefore, depending on the execution condition of the next printing job and the execution timing of the printing job, printing may not be performed in a stable fixation state, and image defect may be caused due to the temperature drop of the surface of the fixing member.

### SUMMARY OF THE INVENTION

An object of the present invention is to provide an image forming apparatus, an image formation system and a method of controlling a heating amount which can suppress image defect due to temperature drop of the surface of a fixing member.

To achieve the abovementioned object, an image forming apparatus reflecting one aspect of the present invention includes: a fixing member configured to fix an unfixed toner image formed on a sheet to the sheet at a fixing nip; a heating section configured to heat the fixing member; and a control section configured to control the heating section such that, when an operation state of the fixing member is transferred from a first operation state in which fixation is performed to a second operation state, the heating section heats the fixing member with a first heating amount during a period from a first timing at which the first operation state is started until a second timing which is a timing before the first operation state is completed, and the heating section heats the fixing member with a second heating amount smaller than the first heating amount and greater than 0 during a period from the second timing until a third timing at which the second operation state is started.

Desirably, in the image forming apparatus, the control section changes a value of the second heating amount in accordance with the second operation state.

Desirably, in the image forming apparatus, the control section determines whether there is a possibility of overshooting of a surface temperature of the fixing member after completion of the first operation state; and, only when it is determined that there is a possibility of overshooting, the control section controls the heating section to heat the fixing member with the first heating amount during the period from the first timing until the second timing, and heat the fixing member with the second heating amount during the period from the second timing until the third timing.

Desirably, in the image forming apparatus, the control section changes a value of the second heating amount in accordance with the second operation state and a voltage value of a power source used in the heating section.

Desirably, in the image forming apparatus, the control section changes a value of the second heating amount in accordance with the second operation state and a temperature and a humidity around the image forming apparatus.

Desirably, in the image forming apparatus, the control section changes the second heating amount in accordance with the second operation state and a type of the sheet.

Desirably, in the image forming apparatus, the control section changes the second heating amount in accordance with the second operation state and a use history of the fixing member.

Desirably, in the image forming apparatus, when the second operation state is an operation state in which the fixation is performed, the control section determines the second heating amount such that fixation failure is not caused in the second operation state.

Desirably, in the image forming apparatus, the control section controls a heating amount of the heating section based on an on-and-off pattern in a unit of half-wave of a predetermined duty ratio.

Desirably, in the image forming apparatus: the heating section includes a plurality of heat generation members arranged at different positions in an axial direction of the fixing member; and the control section selectively controls a heating amount of any of the heat generation members in accordance with a type of the sheet.

Desirably, in the image forming apparatus, the second timing is a timing before a last sheet to be subjected to the fixation passes through the fixing nip.

Desirably, in the image forming apparatus, the second timing is a timing at which a last sheet to be subjected to the fixation passes through the fixing nip.

To achieve the abovementioned object, an image formation system reflecting one aspect of the present invention includes a plurality of units including an image forming apparatus, the image forming apparatus including: a fixing member configured to fix an unfixed toner image formed on a sheet to the sheet at a fixing nip; a heating section configured to heat the fixing member; and a control section configured to control the heating section such that, when an operation state of the fixing member is transferred from a first operation state in which fixation is performed to a second operation state, the heating section heats the fixing member with a first heating amount during a period from a first timing at which the first operation state is started until a second timing which is a timing before the first operation state is completed, and the heating section heats the fixing member with a second heating amount smaller than the first heating amount and greater than 0 during a period from the second timing until a third timing at which the second operation state is started.

To achieve the abovementioned object, a method reflecting one aspect of the present invention includes is a method of controlling a heating amount of an image forming apparatus including a fixing member configured to fix an unfixed toner image formed on a sheet to the sheet at a fixing nip; and a heating section configured to heat the fixing member, the method including: controlling the heating section such that, when an operation state of the fixing member is transferred from a first operation state in which fixation is performed to a second operation state, the heating section heats the fixing member with a first heating amount during a period from a first timing at which the first operation state is started until a second timing which is a timing before the first operation state is completed, and the heating section heats the fixing member with a second heating amount smaller than the first heating amount and greater than 0 during a period from the second timing until a third timing at which the second operation state is started.

Desirably, in the method, a value of the second heating amount is changed in accordance with the second operation state.

Desirably, in the method, whether there is a possibility of overshooting of a surface temperature of the fixing member after completion of the first operation state is determined; and, only when it is determined that there is a possibility of overshooting, the heating section is controlled to heat the fixing member with the first heating amount during the period from the first timing until the second timing, and heat the fixing member with the second heating amount during the period from the second timing until the third timing.

Desirably, in the method, a value of the second heating amount is changed in accordance with the second operation state and a voltage value of a power source used in the heating section.

Desirably, in the method, a value of the second heating amount is changed in accordance with the second operation state and a temperature and a humidity around the image forming apparatus.

Desirably, in the method, the second heating amount is changed in accordance with the second operation state and a type of the sheet.

Desirably, in the method, the second heating amount is changed in accordance with the second operation state and a use history of the fixing member.

### BRIEF DESCRIPTION OF DRAWINGS

FIG. 1 schematically illustrates a general configuration of an image forming apparatus according to an embodiment;

FIG. 2 illustrates a principal part of a control system of the image forming apparatus according to the embodiment;

FIG. 3A is a timing chart of a relationship between a temperature state of an upper fixing section and an output state of a heating source in a conventional technology;

FIG. 3B is a timing chart of a relationship between a temperature state of an upper fixing section and an output state of a heating source in the embodiment;

FIG. 4A shows an on-and-off pattern in a unit of half-wave of a duty ratio of 100%;

FIG. 4B shows an on-and-off pattern in a unit of half-wave of a duty ratio of 80%;

FIG. 4C shows an on-and-off pattern in a unit of half-wave of a duty ratio of 40%;

FIG. 4D shows an on-and-off pattern in a unit of half-wave of a duty ratio of 20%;

FIG. 5 is a flowchart of an exemplary operation of heating amount control of the image forming apparatus;

FIG. 6 is a timing chart of a relationship between the output state of the heating source and the surface temperature state of the upper fixing section in the evaluation of Example 2;

FIG. 7 is a timing chart of a relationship between the output state of the heating source and the surface temperature state of the upper fixing section in the evaluation of Example 3; and

FIG. 8 is a timing chart of a relationship between the output state of the heating source and the surface temperature state of the upper fixing section in the evaluation of Example 4.

### DESCRIPTION OF THE PREFERRED EMBODIMENT

In the following, the present embodiment is described in detail with reference to the drawings.

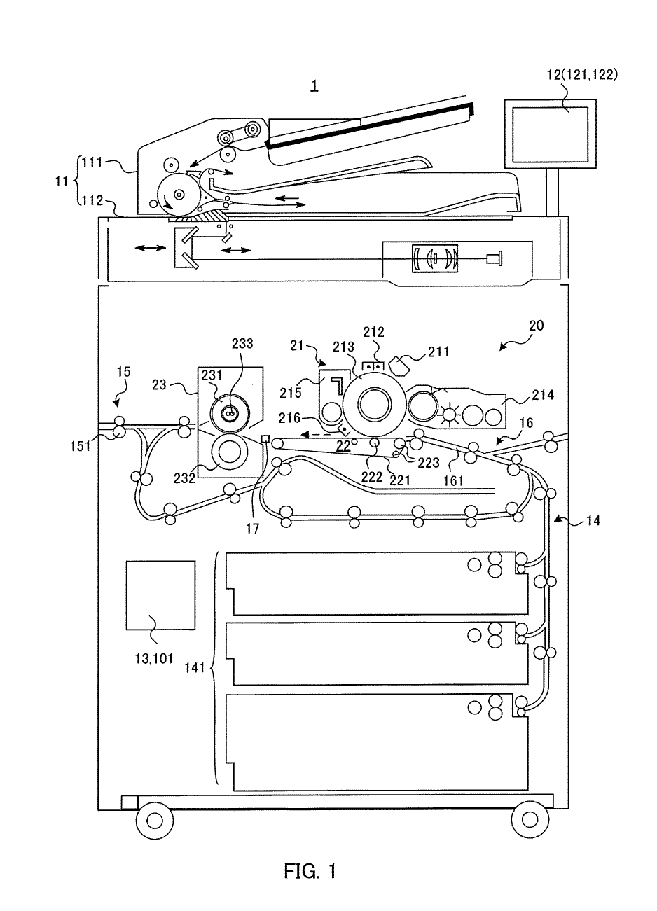

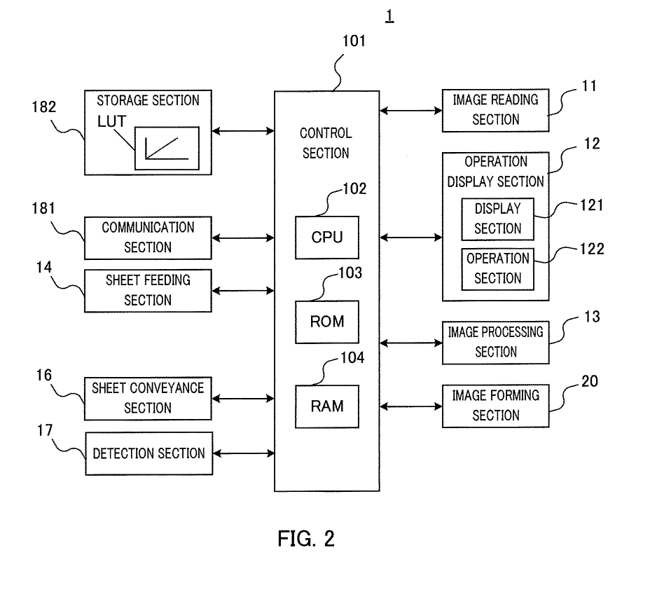

FIG. 1 illustrates an overall configuration of image forming apparatus 1 according to the present embodiment. FIG. 2 illustrates a principal part of a control system of image forming apparatus 1 according to the embodiment.

Image &liming apparatus 1 illustrated in FIG. 1 and FIG. 2 is a monochrome image forming apparatus of a direct transfer type which uses electrophotographic process technology. That is, image forming apparatus 1 directly transfers a toner image of a K-component (black) formed on photoconductor drum 213 to a sheet to form an image.

Image forming apparatus 1 includes image reading section 11, operation display section 12, image processing section 13, image forming section 20, sheet feeding section 14, sheet conveyance section 16, detection section 17 and control section 101.

Control section 101 includes central processing unit (CPU) 102, read only memory (ROM) 103, random access memory (RAM) 104 and the like. CPU 102 reads a program suited to processing details out of ROM 103 or storage section 182, develops the program in RAM 104, and integrally controls an operation of each block of image forming apparatus 1 in cooperation with the developed program.

Communication section 181 has various interfaces such as network interface card (NIC), modulator-demodulator (MODEM), and universal serial bus (USB), for example.

Storage section 182 is composed of, for example, a non-volatile semiconductor memory (so-called flash memory) or a hard disk drive. Storage section 182 stores therein a look-up table which is referenced when the operation of each block is controlled, for example.

Control section 101 transmits and receives various data to and from an external apparatus (for example, a personal computer) connected to a communication network such as a local area network (LAN) or a wide area network (WAN), through communication section 181. Control section 101 receives image data (input image data) of page description language (PDL) that has been sent from an external device, and controls the apparatus to form an image on a sheet on the basis of the data, for example.

Image reading section 11 includes an automatic document feeder 111 called auto document feeder (ADF), document image scanner (scanner) 112, and the like. Auto document feeder 111 causes a conveyance mechanism to feed documents placed on a document tray, and sends out the documents to document image scanner 112. Auto document feeder 111 enables images (even both sides thereof) of a large number of documents placed on the document tray to be successively read at once. Document image scanner 112 optically scans a document fed from auto document feeder 111 to its contact glass or a document placed on its contact glass, and images light reflected from the document on the light receiving surface of a charge coupled device (CCD) sensor, to thereby read the document image. Image reading section 11 generates input image data on the basis of a reading result provided by document image scanner 112. Image processing section 13 performs predetermined image processing on the input image data.

Operation display section 12 includes, for example, a liquid crystal display (LCD) with a touch panel, and functions as display section 121 and operation section 122. Display section 121 displays various operation screens, image conditions, operating statuses of respective functions, and the like in accordance with display control signals received from control section 101. Operation section 122 includes various operation keys such as numeric keys and a start key, receives various input operations performed by a user, and outputs operation signals to control section 101.

By operating operation display section 12, the user can perform setting relating to the image formation such as document setting, image quality setting, multiplying factor setting, application setting, output setting, single-sided/duplex printing setting, and sheet setting (including the basis weight of the sheet, and presence of gloss). The information thus set is stored in storage section 182 for example.

Image processing section 13 includes a circuit that performs a digital image process suited to initial settings or user settings on the input image data, and the like. For example, image processing section 13 performs tone correction on the basis of tone correction data under the control of control section 101. Image processing section 13 also performs various correction processes such as color correction and shading correction on the input image data. Image forming section 20 is controlled on the basis of the image data that has been subjected to these processes.

Image forming section 20 includes: toner image forming section 21 configured to form a toner image of a K-component on the basis of the input image data; transfer section 22 configured to transfer a toner image formed by toner image forming sections 21 to a sheet; fixing section 23 configured to fix a transferred toner image to a sheet; and the like.

Toner image forming section 21 includes exposing device 211, charging device 212, photoconductor drum 213, developing device 214, drum cleaning device 215, discharging device 216, and the like.

Photoconductor drum 213 is a negative-charging type organic photoconductor (OPC) in which an undercoat layer (UCL), a charge generation layer (CGL), and charge transport layer (CTL) are sequentially stacked on a peripheral surface of a conductive cylindrical body made of aluminum (aluminum raw pipe), for example.

Charging device 212 is composed of a corona discharging generator such as a scorotron charging device and a corotron charging device, for example. Charging device 212 evenly negatively charges the surface of photoconductor drum 213 by corona discharge.

Exposing device 211 is composed of, for example, an LED print head including an LED array having a plurality of linearly laid out light-emitting diodes (LED), an LPH driving section (driver IC) for driving each LED, an lens array that brings light radiated from the LED array into an image on photoconductor drum 213, and the like. Each of the LEDs of the LED array corresponds to one dot of an image. When the LPH driving section is controlled by control section 101, a predetermined driving current flows through the LED array, and designated LEDs emit light.

Exposing device 211 irradiates photoconductor drum 213 with light corresponding to a monochrome image. The positive charge generated in the charge generation layer of photoconductor drum 213 irradiated with light is transported to the surface of the charge transport layer, whereby the surface charge (negative charge) of photoconductor drum 213 is neutralized. Thus, an electrostatic latent image is formed on the surface of photoconductor drum 213 by the potential difference from its surroundings.

Developing device 214 stores developer of a K-component (for example, a two-component developer composed of toner and magnetic carrier). Developing device 214 attaches toner of a K-component to the surface of photoconductor drum 213, and visualizes the electrostatic latent image to form a toner image. To be more specific, a developing bias is applied to a developer bearing member (developing roller), and a development electric field is formed between photoconductor drum 213 and the developer bearing member. By the potential difference between photoconductor drum 213 (negative) and the developer bearing member, the charging toner (negative) on the developer bearing member is caused to move and attach to a light exposure section on the surface of photoconductor drum 213. That is, developing device 214 develops an electrostatic latent image by a reversal development scheme.

Drum cleaning device 215 includes a drum cleaning blade which is brought into sliding contact with the surface of photoconductor drum 213 and the like, and removes the transfer residual toner remaining on the surface of photoconductor drum 213 after the transfer.

Discharging device 216 is composed of a corotron charging device including a discharging electrode and a discharging power source, for example. In the rotational direction of photoconductor drum 213, discharging device 216 is disposed between transfer section 22 (transfer roller 222) and charging device 212. When control section 101 controls the output (such as the discharging output and the discharging bias) of a discharging power source, a predetermined discharge current flows to the discharging electrode from photoconductor drum 213. In this manner, the residual electric charge remaining on the surface of photoconductor drum 213 after the transfer is removed.

Transfer section 22 includes transfer belt 221, transfer roller 222, a plurality of support rollers 223, and a transferring power source (not illustrated) and the like.

Transfer belt 221 is composed of an endless belt, and is stretched around support rollers 223 in a loop form. At least one of support rollers 223 is composed of a driving roller, and the others are each composed of a driven roller. When the driving roller rotates, transfer belt 221 travels and a sheets is conveyed at a constant speed.

Transfer roller 222 is disposed on the internal periphery side of transfer belt 221 in such a manner as to face photoconductor drum 213. Transfer roller 222 is brought into pressure contact with photoconductor drum 213 with transfer belt 221 therebetween, whereby a transfer nip for transferring a toner image from photoconductor drum 213 to a sheet is formed.

The transferring power source is connected with transfer roller 222. When control section 101 controls the output of the transferring power source (transfer output), a predetermined transfer current flows to photoconductor drum 213 from transfer roller 222.

When a sheet passes through the transfer nip, the toner image on photoconductor drum 213 is transferred to the sheet. To be more specific, a transfer output (transfer bias) is applied to transfer roller 222, and an electric charge (positive charge) having a polarity opposite to that of the toner is applied to the rear side (the side that makes contact with transfer belt 221) of the sheet, whereby the toner image is electrostatically transferred to the sheet. The sheet on which the toner image has been transferred is conveyed toward fixing section 23.

Fixing section 23 includes upper fixing section 231 composed of a fixing roller disposed on the fixing surface (the surface on which a toner image is formed) side of a sheet, lower fixing section 232 composed of a pressure roller disposed on the rear surface (the surface opposite to the fixing surface) side of a sheet, heating source 233 configured to heat upper fixing section 231, a pressure contact separation section (not illustrated) configured to bring lower fixing section 232 into pressure contact with upper fixing section 231, and the like. Upper fixing section 231 and heating source 233 correspond to the “fixing member” and the “heating section” of the embodiment of the present invention, respectively.

Upper fixing section 231 includes an upper fixing section-driving section (not illustrated) for rotating the fixing roller. When control section 101 controls the operation of the upper fixing section-driving section, upper fixing section 231 rotates (travels) at a predetermined speed. Lower fixing section 232 includes a lower fixing section-driving section (not illustrated) for rotating the pressure roller. When control section 101 controls the operation of the lower fixing section-driving section, lower fixing section 232 rotates (travels) at a predetermined speed. It is to be noted that the upper fixing section-driving section is not required in the case where upper fixing section 231 follows the rotation of lower fixing section 232.

Heating source 233 is disposed inside upper fixing section 231, and includes a plurality of heat generation members. When control section 101 controls the output of heating source 233, upper fixing section 231 is heated, and the temperature is maintained at a predetermined temperature (such as a fixable temperature and an idling temperature, for example). On the basis of the detection result of a fixing temperature detection section (not illustrated) disposed at a position near upper fixing section 231, control section 101 controls the output of heating source 233.

The pressure contact separation section (not illustrated) presses the pressure roller toward the fixing roller. The pressure contact separation section makes contact with the both ends of a shaft that supports the pressure roller to separately press each end, for example. With this structure, the balance of the nip pressure in the direction along the shaft in the fixing nip can be adjusted. When control section 101 controls the operation of the pressure contact separation section (not illustrated) such that the pressure roller is brought into pressure contact with the fixing roller, a fixing nip for conveying a sheet in a tightly sandwiching manner is formed.

Heat and pressure are applied to a sheet on which a toner image has been transferred and which has been conveyed along a sheet feeding path at the time when the sheet passes through fixing section 23. Thus, the toner image is fixed to the sheet.

In addition, detection section 17 is provided on the upstream side of the fixing nip at fixing section 23. Detection section 17 is a sensor for detecting a passing of a sheet, and informs control section 101 of the passing of a sheet.

Sheet feeding section 14 includes sheet feed tray section 141. Flat sheets (standard type sheets and special type sheets) discriminated on the basis of their basis weight, size and the like are stored in sheet feed tray section 141 in advance on a predetermined type basis. A plurality of sheet feeding roller sections are disposed in sheet feed tray section 141. Sheet feeding section 14 sends a sheet fed from sheet feed tray section 141 to sheet conveyance section 16.

Sheet ejection section 15 includes sheet ejection roller section 151 and the like, and ejects a sheet output by sheet conveyance section 16 out of the apparatus.

Sheet conveyance section 16 includes main conveyance section 161 and the like. A part of sheet conveyance section 16 is incorporated in one unit (sheet conveyance unit ADU) together with fixing section 23, and detachably mounted to image forming apparatus 1, for example.

Main conveyance section 161 includes a plurality of conveyance roller sections including a loop roller section and a registration roller section which serve as sheet-conveyance elements for conveying sheets in a sandwiching manner. Main conveyance section 161 conveys a sheet fed from sheet feed tray section 141 through image forming section 20 (transfer section 22 and fixing section 23), and conveys a sheet output from image forming section 20 (fixing section 23) toward sheet ejection section 15.

A sheet fed from sheet feeding section 14 is conveyed to image forming section 20 by main conveyance section 161. Thereafter, a toner image on photoconductor drum 213 is transferred to a first surface (front surface) of the sheet at one time at the time when the sheet passes through the transfer nip, and then a fixing process is performed in fixing section 23. A sheet on which an image is formed is ejected out of the apparatus by sheet ejection section 15.

Incidentally, in the above-mentioned image forming apparatus 1, the heat of upper fixing section 231 is removed by the fixing nip during the printing job. However, when a printing job for 100 or more sheets is executed for example, heating is continuously performed by heating source 233 during the printing job and the temperature of the inside and the surface is set to a saturated state where no more temperature rise of the inside and the surface is caused. In this case, the removal of heat from the surface of upper fixing section 231 does not occur after the last sheet passes through the fixing nip, and the heat is transmitted to the surface in the saturated state from the inside with a delay. As a result, the surface temperature of upper fixing section 231 is greatly varied by overshooting.

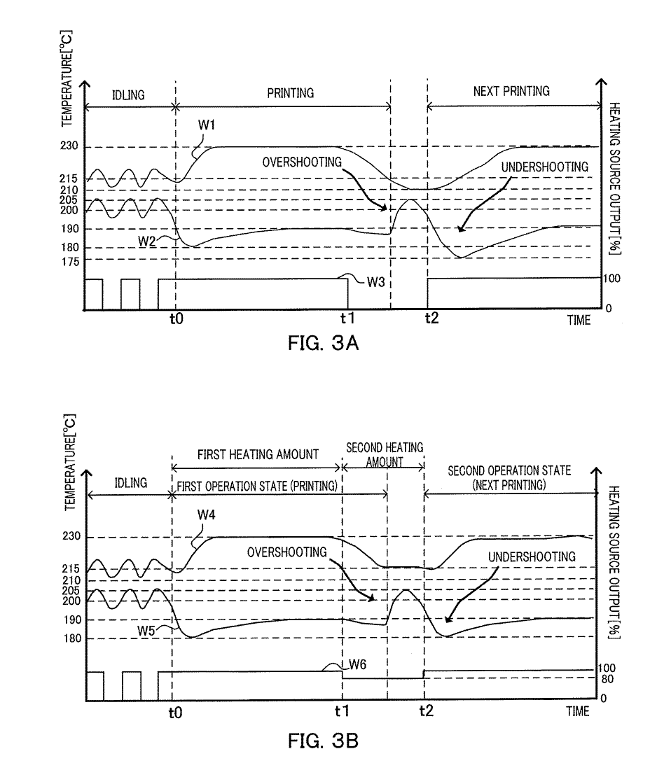

As measures against such overshooting, a method of the conventional technique illustrated in FIG. 3A has been proposed in which the internal temperature of upper fixing section 231 is reduced by turning off the output of heating source 233 (time t1) after the last sheet is fed toward the fixing nip in a printing job. In FIG. 3A, waveform W1 indicates the internal temperature of upper fixing section 231, waveform W2 the surface temperature of upper fixing section 231, and waveform W3 the output state of heating source 233.

In this manner, after the completion of the printing job, the temperature rise of the surface of upper fixing section 231 due to overshooting can be suppressed to a temperature substantially equal to the upper limit of the temperature of the idling state for example. However, when the internal temperature of upper fixing section 231 is reduced, it becomes necessary to again heat the inside of upper fixing section 231 when starting the next printing job (time t2), and consequently the temperature variation of upper fixing section 231 due to undershooting is increased. In particular, in the case where upper fixing section 231 is a fixing roller, the surface is a rubber layer, and therefore heat transmission from the inside to the surface tends to be delayed, and as a result, the temperature variation due to undershooting tends to be increased.

In view of this, in the present embodiment, in the case where a printing job is transferred from a first operation state to a second operation state (the next printing job in FIG. 3B), control section 101 controls heating source 233 to heat upper fixing section 231 with the first heating amount during a period from a first timing (time t0) at which the first operation state is started to a second timing (time t1) before the first operation state is completed, as illustrated in FIG. 3B. Then, during a period from the second timing until a third timing (time t2) at which the second operation state is started, control section 101 controls heating source 233 to heat upper fixing section 231 with a second heating amount smaller than the first heating amount and greater than 0. In FIG. 3B, waveform W4 indicates the internal temperature of upper fixing section 231, waveform W5 the surface temperature of upper fixing section 231, and waveform W6 the output state of heating source 233.

Specifically, before the last sheet of the printing job passes through the fixing nip, that is, at the second timing at which a passing of the last sheet is detected by detection section 17, control section 101 changes the output of heating source 233 from the first heating amount to the second heating amount. It is to be noted that the second timing may be a timing after the last sheet passes through the fixing nip. In addition, the second timing may be determined based on the number of prints in the reserved printing job.

In this manner, it is not necessary to again heat the inside of upper fixing section 231, and consequently heat transmission from the inside to the surface is improved in the second operation state (in FIG. 3B, the next printing job). In this manner, variation of the surface temperature due to undershooting can be reduced.

Control section 101 determines whether there is a possibility of overshooting of the surface temperature of upper fixing section 231 after the completion of the first operation state. Only when it is determined that there is a possibility of overshooting of the surface temperature of upper fixing section 231, control section 101 controls heating source 233 to heat upper fixing section 231 with the first heating amount during a period from the first timing until the second timing, and heat upper fixing section 231 with the second heating amount during a period from the second timing until the third timing.

It is to be noted that the overshooting of the surface temperature of upper fixing section 231 refers to a situation where the surface temperature of upper fixing section 231 exceeds the first predetermined temperature, for example. In addition, the first predetermined temperature may be a temperature higher than a setting temperature of upper fixing section 231 (for example, 200[° C.]) by 5[° C.] for example, and may be appropriately changed.

When the number of prints in a reserved printing job is greater than a predetermined number of sheets (for example, 100 sheets), control section 101 can determine that there is a possibility of overshooting of the surface temperature of upper fixing section 231. One reason for this is that saturation of the internal temperature and the surface temperature of upper fixing section 231 can be determined based on the number of prints.

In addition, control section 101 can determine, with a temperature sensor and the like, that there is a possibility of overshooting of the surface temperature of upper fixing section 231 when it is detected that the internal temperature of upper fixing section 231 is higher than a predetermined temperature (for example, 215[° C.] in FIG. 3), and when it is detected that the temperature is higher than a minimum temperature (for example, 180[° C.] in FIG. 3) of the surface temperature of upper fixing section 231 during the printing job under execution. One reason for this is that saturation of the internal temperature or the surface temperature of upper fixing section 231 can be determined by detecting the above-mentioned temperatures.

It is to be noted that control section 101 may determine the possibility of overshooting of the surface temperature of upper fixing section 231 based on the temperature and the humidity around image forming apparatus 1, the type of the sheet, the basis weight of the sheet and the like. In addition, one or a combination of the above-mentioned conditions for determining overshooting may be adopted.

Incidentally, since the object which removes heat from the surface of upper fixing section 231 differs depending on the operation state of fixing section 23, the proper value of the output value of heating source 233 required for saturation of the internal temperature of upper fixing section 231 differs among jobs.

In the present embodiment, during a printing job, a sheet passing through the fixing nip, lower fixing section 232 and the surrounding air are the objects which remove heat from upper fixing section 231, and therefore the output of heating source 231 is 80[%] of the maximum heating amount, for example. In addition, during a preliminary rotation state before a printing job, lower fixing section 232 and the surrounding air are the objects which remove heat from upper fixing section 231, and the number of the objects are smaller than that of the printing job, and therefore, the output of heating source 231 is 40[%] of the maximum heating amount, for example. In addition, during an idling state, the surrounding air is the object which removes heat from upper fixing section 231, and the number of the objects is smaller than that of the printing job and the preliminary rotation state, and therefore the output of heating source 231 is 20[%] of the maximum heating amount, for example. It is to be noted that the proper value of the heating amount of heating source 233 may be appropriately changed.

In view of this, control section 101 operates to change the second heating amount (80[%] in FIG. 3B) in accordance with the second operation state. In this manner, the responsiveness of the surface temperature of upper fixing section 231 at the time of transition to the second operation state is improved.

Specifically, when the second operation state is a printing job, control section 101 can set the second heating amount to a heating amount of 80[%] of the maximum heating amount of heating source 233, and when the second operation state is a preliminary rotation state, control section 101 can set the second heating amount to a heating amount of 40[%] of the maximum heating amount of heating source 233. In addition, when the second operation state is an idling state, control section 101 can set the second heating amount to a heating amount of 20[%] of the maximum heating amount of heating source 233.

Control section 101 may change the second heating amount in accordance with at least one of the second operation state, the voltage value of the power source used in heating source 233, the temperature and humidity around image forming apparatus 1, the type of the sheet and the use history of upper fixing section 231. When the above-mentioned conditions are used in combination, control section 101 may use only conditions set in advance in storage section 182 and the like, or may use any of the conditions input by the user.

When the second operation state is an operation state for performing fixation, that is, when the second operation state is a printing job, control section 101 determines the second heating amount such that fixation failure is not caused in the second operation state. For example, when the output of heating source 233 is changed from the second heating amount to the first heating amount in the second operation state, control section 101 determines the second heating amount such that the difference between the minimum temperature of the surface of upper fixing section 231 in the first operation state and the minimum temperature of the surface of upper fixing section 231 in the second operation state is smaller than a second predetermined temperature (for example, 5[° C.]). With this configuration, the temperature variation due to undershooting at the start of the second operation state is reduced, and a stable fixation state is maintained.

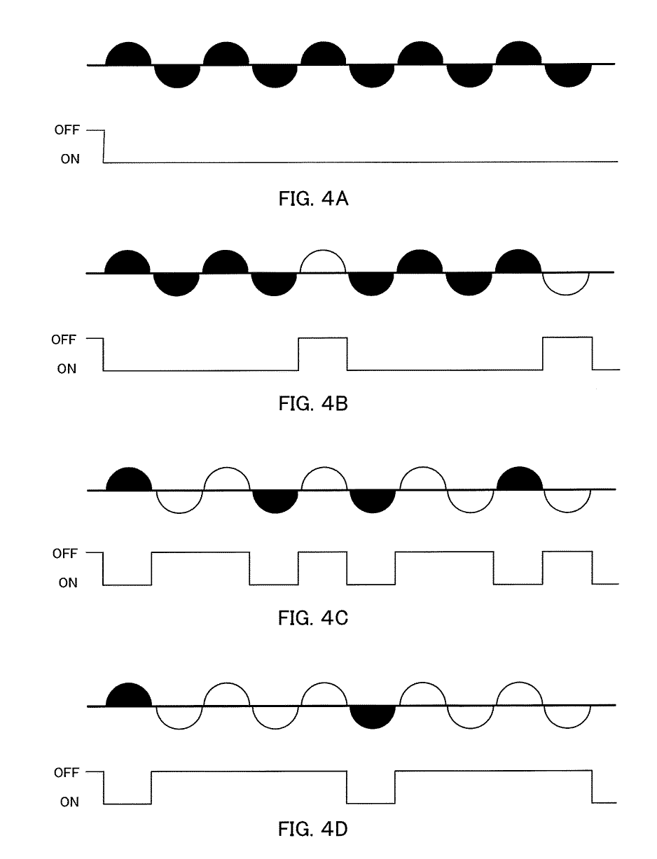

As illustrated in FIG. 4A, FIG. 4B, FIG. 4C and FIG. 4D, control section 101 controls heating source 233 based on an on-and-off pattern in a unit of half-wave of a predetermined duty ratio. Control section 101 controls the output of heating source 233 based on the waveform in a unit of half-wave disclosed in Japanese Patent Application Laid-Open No. 2015-99334, for example. In each of FIG. 4A, FIG. 4B, FIG. 4C and FIG. 4D, a waveform of an on-and-off pattern in a unit of half-wave of each output value of heating source 233 is illustrated on the upper side, and the on/off state of heating source 233 in the on-and-off pattern is illustrated on the lower side.

Specifically, when the output of heating source 233 is set to the maximum heating amount, that is, a heating amount of 100[%], control section 101 sets a waveform of an on-and-off pattern of a duty ratio of 100[%] illustrated in FIG. 4A, and when the output of heating source 233 is set to a heating amount of 80[%] of the maximum heating amount, control section 101 sets a waveform of an on-and-off pattern of a duty ratio of 80[%] illustrated in FIG. 4B. When the output of heating source 233 is set to a heating amount of 40[%] of the maximum heating amount, control section 101 sets a waveform of an on-and-off pattern of a duty ratio of 40[%] illustrated in FIG. 4C, and when the output of heating source 233 is set to a heating amount of 20[%] of the maximum heating amount, control section 101 sets a waveform of an on-and-off pattern of a duty ratio of 20[%] illustrated in FIG. 4D. In this manner, the heating amount of heating source 233 can be controlled to a precise value.

In addition, when the above-described plurality of heat generation members are arranged in different positions in the axial direction of upper fixing section 231, control section 101 may selectively control the heating amount of any of the heat generation members in accordance with the type of the sheet. With this configuration, in the case of a heat distribution configuration in which the heat generation members have respective different roles, control section 101 needs only to control the output of the required heat generation member by separately changing the heating amounts of the heat generation members, for example. Therefore, for example, this configuration is advantageous in a case where sheets of different sizes are alternately printed in which the temperature transition is different between the center portion and the end portions in the axial direction of fixing section 23.

Next, an exemplary operation for the heating amount control of image forming apparatus 1 including the above-mentioned control section 101 will be described.

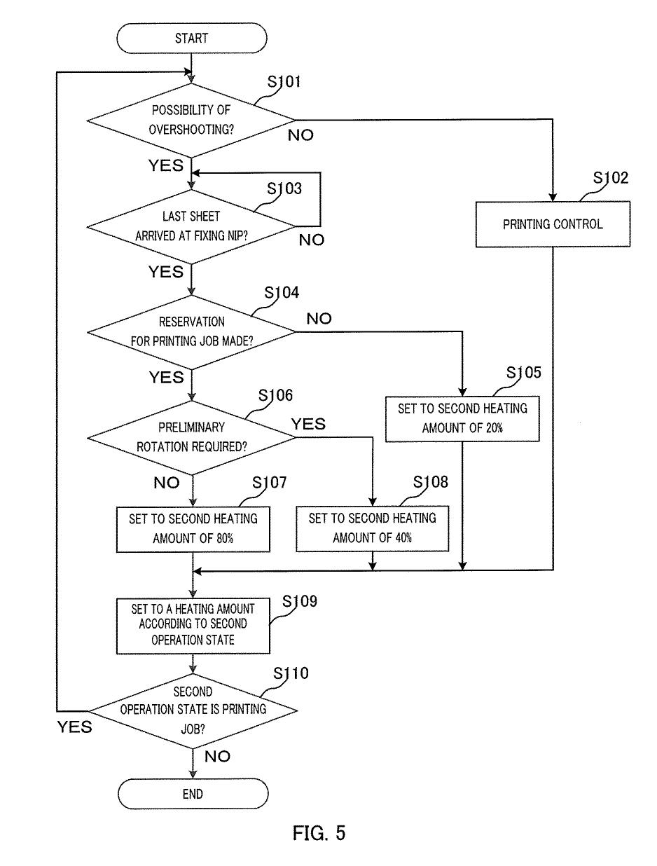

FIG. 5 is a flowchart of an exemplary operation for the heating amount control of image forming apparatus 1. The processing in FIG. 5 is executed when control section 101 receives a request for execution of a printing job.

First, control section 101 determines whether there is a possibility of overshooting of the surface temperature of upper fixing section 231 (step S101). Specifically, control section 101 determines the possibility of overshooting based on whether the number of prints in a reserved printing job is not smaller than a predetermined number of sheets.

When it is determined that there is no possibility of overshooting (step S101, NO), control section 101 executes a printing control in the printing job (step S102), and the process is advanced to step S109.

On the other hand, when it is determined that there is a possibility of overshooting (step S101, YES), control section 101 determines whether the final sheet in the printing job has reached the fixing nip (step S103). When it is determined that the final sheet has not reached the fixing nip (step S103, NO), control section 101 repeats the process of step S103.

When it is determined that the final sheet has reached the fixing nip (step S103, YES), control section 101 determines whether a reservation for printing job has been made (step S104). When it is determined that there is no reservation for a printing job (step S104, NO), control section 101 sets the output of heating source 233 to a second heating amount of 20[%] of the maximum heating amount (step S105), and the process is advanced to step S109.

When it is determined that there is a reservation for a printing job (step S104, YES), control section 101 determines whether preliminary rotation is required (step S106). When it is determined that preliminary rotation is not required (step S106, NO), control section 101 sets the output of heating source 233 to a second heating amount of 80[%] of the maximum heating amount (step S107). When it is determined that preliminary rotation is required (step S106, YES), control section 101 sets the output of heating source 233 to a second heating amount of 40[%] of the maximum heating amount (step S108).

After S102, S105, S107, and S108, control section 101 sets the output of heating source 233 to a heating amount corresponding to the second operation state (step S109). Specifically, control section 101 sets the output of heating source 233 to a heating amount of the idling state after step S105, and the sets the output of heating source 233 to a heating amount of the printing job after step S107. Control section 101 sets the output of heating source 233 to a heating amount of the preliminary rotation state after step S108. In addition, control section 101 sets the output of heating source 233 to a heating amount in accordance with the operation state at that time after step S102.

Finally, control section 101 determines whether the second operation state is a printing job (step S110). When it is determined that the second operation state is a printing job (step S110, YES), the processing is returned to a phase before process step S101, and when it is determined that the second operation state is not a printing job (step S110, NO), image forming apparatus 1 terminates the processing of FIG. 5.

As described above, Image forming apparatus 1 of the present embodiment includes: upper fixing section 231 configured to fix an unfixed toner image formed on a sheet to the sheet at a fixing nip; heating source 233 configured to heat upper fixing section 231; and control section 101 configured to control heating source 233 such that, when an operation state of upper fixing section 231 is transferred from a first operation state in which fixation is performed to a second operation state, heating source 233 heats upper fixing section 231 with a first heating amount during a period from a first timing at which the first operation state is started until a second timing which is a timing before the first operation state is completed, and heating source 233 heats upper fixing section 231 with a second heating amount smaller than the first heating amount and greater than 0 during a period from the second timing until a third timing at which the second operation state is started.

According to the above-mentioned configuration of the present embodiment, significant variation in temperature of upper fixing section 231 due to overshooting which occurs after the last sheet passes through the fixing nip in a printing job can be reduced by setting the output of heating source 233 to the second heating amount smaller than the first heating amount. In addition, the responsiveness of the temperature variation from the inside to the surface of upper fixing section 231 when the second operation state is set is improved by setting the second heating amount to a proper value in accordance with the second operation state. Therefore, significant variation in temperature of upper fixing section 231 due to undershooting can be reduced. As a result, image defect due to temperature drop of the surface of upper fixing section 231 can be reduced.

In addition, by setting the second heating amount to a proper value in accordance with the second operation state, unevenness of the thermal conductivity from the inside to the surface of upper fixing section 231 can be reduced, and thus the balance of the temperature of the inside and the surface of upper fixing section 231 can be maintained. In this manner, the surface temperature of upper fixing section 231 can be maintained at a stable state at all times, and quick transition to the next job can be achieved. Consequently, productivity in a printing job can be improved.

In addition, in the case where there is a possibility of overshooting of the surface temperature of upper fixing section 231, the output of heating source 233 is switched from the first heating amount to the second heating amount, and thus heating source 233 can be appropriately controlled.

In addition, by using other conditions such as the voltage value of the power source used in heating source 233 in addition to the second operation state, the second heating amount can be set to a further proper value, for example.

In addition, the responsiveness of the temperature in upper fixing section 231 is improved by setting the output of heating source 233 between printing jobs to the second heating amount, and therefore even when an execution request for a highly prioritized printing job is received, the processing can be quickly switched to that printing job, for example.

Finally, an experiment for an evaluation of image forming apparatus 1 according to the present embodiment is described. In this experiment, variation in surface temperature of upper fixing section 231 in overshooting and undershooting in the case where the second heating amount is changed in accordance with the second operation state was evaluated. Image forming apparatus 1 illustrated in FIG. 1 was used for the evaluation.

The condition of the evaluation was as follows. A fixing roller having a surface rubber layer of a thickness of 0.5 [mm] and a heat capacity of 2.0 [kJ/K] was used as upper fixing section 231, and a pressure roller having a surface rubber layer of a thickness of 6.5 [mm] and a heat capacity of 1.3 [kJ/K] was used as lower fixing section 232. It is to be noted that the fixing roller and the pressure roller may have a heat capacity greater than the above-mentioned conditions. In addition, a belt heating type fixing section such as a fixing belt may be employed as fixing section 23.

In the above-mentioned image forming apparatus 1, a fixing temperature in fixing section 23 was set to 200[° C.], the environment condition was set to a normal temperature and a normal humidity, the voltage of a power source used in image forming apparatus 1 was set to 200 [V], and the fixing section was set to an initial state in terms of use history. In addition, the setting temperature, the sheet type of the next job and the second heating amount in Examples were as shown in Table 1.

Table 1 shows a relationship between the setting temperature, the sheet type and the second heating amount in Examples.

TABLE 1

| | Second | | | Second |
|---|---|---|---|---|
| | operation | Setting | Sheet | heating |
| Examples | state | temperature | type | amount |
| Ex 1 | Idling | 200° C. | Plain sheet | 20% |
| Ex 2 | Preliminary | 200° C. | Plain sheet | 40% |
| | rotation | | | |
| Ex 3 | Printing | 200° C. | Plain sheet | 80% |
| Ex 4 | Printing | 200→ | Thick sheet | 80→90% |
| | | 210° C. | | |

Example 4 is an example where a thick sheet (of a basis weight of 150 to 350 [gsm] for example) is selected as the sheet type of a prioritized output in the case where the second heating amount is an amount for the second operation state of a printing job using a plain sheet. Accordingly, in Table 1, the switching of the setting temperature and the second heating amount to the values on the right side in the course of the processing is shown.

After the above-mentioned setting, first, the processing was started from an idling state, and a printing job set for continuous printing for 5,000 A4-plain sheets was started. Thereafter, at a timing before the last sheet passes through the fixing nip, the output of heating source 233 was changed from the first heating amount to the second heating amount, and was then changed to a heating amount of the second operation state. The variation in surface temperature of upper fixing section 231 due to overshooting and undershooting, at the time when the output is changed to the heating amount of the second operation state, was evaluated.

Table 2 shows the evaluations of Examples.

TABLE 2

| | Idling | | Preliminary | | Printing job | | Printing job | |
|---|---|---|---|---|---|---|---|---|
| | (Ex1) | | rotation (Ex2) | | (Ex3) | | (Ex4) | |
| | Over | Under | Over | Under | Over | Under | Over | Under |
| | shooting | shooting | shooting | shooting | shooting | shooting | shooting | shooting |
| Comp | Good | Good | Good | Poor | Good | Poor | Good | Poor |
| Ex | | | | | | | | |
| Ex | Good | Good | Good | Good | Good | Good | Good | Good |

Regarding the overshooting, the evaluation “good” indicates that the temperature variation was in a range of 5 [° C.] with respect to the setting temperature, and the evaluation “poor” indicates that the temperature variation was not in the range of 5[° C.]. Regarding the undershooting, the evaluation “good” indicates that the temperature variation of the minimum temperature of the surface of upper fixing section 231 in the second operation state is smaller than a range of 5 [° C.] with respect to the minimum temperature of the same operation state under a condition where overshooting does not occur, and the evaluation “poor” indicates that the temperature variation of the minimum temperature of the surface of upper fixing section 231 in the second operation state is not smaller than a range of 5[° C.] with respect to the minimum temperature of the same operation state under a condition where overshooting does not occur. It is to be noted that the above-mentioned minimum temperature may be set for each operation state in accordance with the experiment or the like.

It is to be noted that the condition for the comparative example of each example was identical to that of the example except that the output of heating source 233 is set to an off state, that is, the heating amount is set to 0 during a period after the last sheet of the previous printing job passes through the fixing nip until the next job is started.

With reference to the results of Examples 2, 3 and 4 in Table 2, the evaluation on undershooting in each comparative example was “poor,” whereas the evaluation on undershooting in each example was “good.”

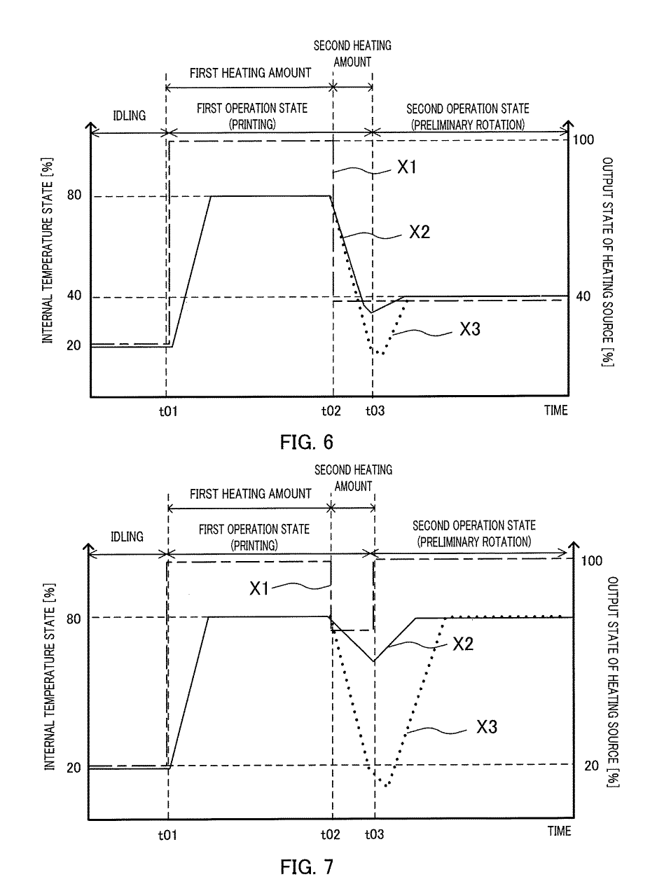

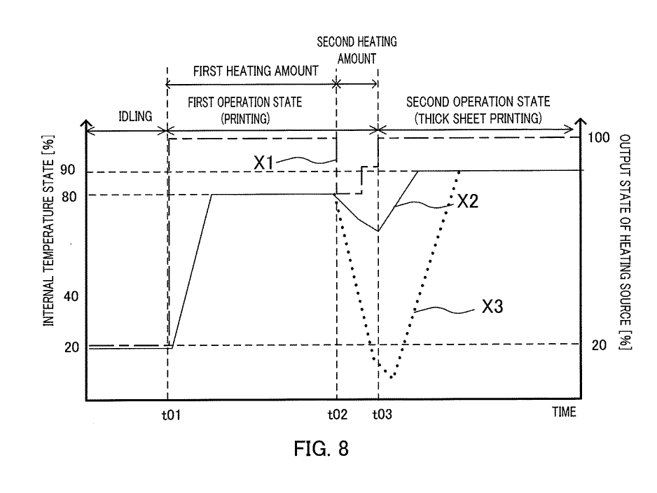

FIG. 6 is a timing chart showing a relationship between the output state of heating source 233 and the internal temperature state of upper fixing section 231 on the basis of the evaluations of Example 2. FIG. 7 is a timing chart showing a relationship between the output state of heating source 233 and the internal temperature state of upper fixing section 231 on the basis of the evaluations of Example 3. FIG. 8 is a timing chart showing a relationship between the output state of heating source 233 and the internal temperature state of upper fixing section 231 on the basis of the evaluations of Example 4.

It is to be noted that, in FIGS. 6, 7, and 8, time t01 is the first timing, time t02 the second timing, and time t03 the third timing. In addition, in FIGS. 6, 7, and 8, waveform X1 indicates the output state of heating source 233, waveform X2 the internal temperature state of upper fixing section 231, and waveform X3 the internal temperature state of upper fixing section 231 in the comparative example. In addition, the internal temperature state of upper fixing section 231 indicates the ratio of a temperature state with respect to a temperature state of the case where the heat of upper fixing section 231 is not removed by a sheet and the like when the output of heating source 233 is maximized.

It is confirmed from FIGS. 6, 7, and 8 that, in the comparative example, heating is again performed by heating source 233 in the second operation state, and consequently the increase of the internal temperature of upper fixing section 231 is delayed, and, undershooting easily occur. In addition, as the output state of heating source 233 in the second operation state is increased, the variation in internal temperature of upper fixing section 231 is increased, and the influence of undershooting becomes further remarkable.

In contrast, in the Examples, it is confirmed that the internal temperature of upper fixing section 231 is within the range of the variation resulting from the switching of the output of heating source 233 to the second heating amount, and consequently the surface temperature of upper fixing section 231 quickly increases also at the time of start of the second operation state.

It is to be noted that, in FIGS. 6, 7, and 8, the internal temperature of upper fixing section 231 is 80[%] when the output of heating source 233 is set at 100[%]. One reason for this is that the heat of upper fixing section 231 is removed by a sheet passing through the fixing nip in the printing, thus reducing the internal temperature.

In addition, in Example 4, it is confirmed that, even when a job requiring a different fixing temperature is suddenly requested in the state where the second heating amount is set, the output of heating source 233 can be quickly changed, and thus the processing can be quickly switched to the second operation state.

In addition, as shown in Table 2, Example 1 is not different from the comparative example in evaluation result. One possible reason for this is as follows. Specifically, in the idling state, heat is not easily removed from the surface of upper fixing section 231 in comparison with the other operation states, and in addition, the output of heating source 233 is small. Accordingly, the internal temperature of upper fixing section 231 is easily transmitted to the surface, and the temperature variation due to undershooting in the comparative example is small.

In addition, in the examples and comparative examples, the evaluation on overshooting is “good.” It is confirmed from the evaluation that, in the examples, overshooting can be reduced by changing the output of heating source 233 from the first heating amount to the second heating amount.

In addition, the control of control section 101 may be performed under a condition where conditions shown in Table 3 and Table 4 are appropriately added to the condition of the above-mentioned experiment. Table 3 shows the shifting amount of the second heating amount for each condition, and Table 4 shows the second heating amount for each sheet type.

TABLE 3

| | | | | | | Temperature difference | | | | |
|---|---|---|---|---|---|---|---|---|---|---|
| | | | Power source | | | between current job and | | | | |
| | | | voltage | | | next job | | | Use history | |
| | Environment | | [V] | | | −5° C. | −5 to | 5° C. | Initial | End |
| | HH/NN | LL | 180 | 200 | 230 | or below | 5° C. | or above | state | state |
| Shifting | 0% | 5% | 5% | 0% | −5% | −5% | 0% | 5% | 0% | 5% |
| amount | | | | | | | | | | |

TABLE 4

| | Basis | Second |
|---|---|---|
| Sheet | weight | heating |
| type | [gsm] | amount [%] |
| Thin | 40-62 | 75 |
| sheet | | |
| Plain | 62-150 | 80 |
| sheet | | |
| Thick | 150-350 | 85 |
| sheet | | |

As shown in Table 3, regarding the environment condition, that is, the temperature and humidity around image forming apparatus 1, the shifting amount is set to 0[%] in the case of a normal temperature and a normal humidity (NN) and a high temperature and a high humidity (HH), whereas the shifting amount is set to 5 [%] in the case of a low temperature and a low humidity (LL). One reason for this is that, when the temperature and humidity around image forming apparatus 1 is a low temperature and a low humidity, the temperature of upper fixing section 231 easily drops.

Regarding the power source voltage, when 200 [V] is set as a reference (0[%]) as in the experiment, the shifting amount is set to 5[%] in case of 180 [V], and the shifting amount is set to −5[%] in the case of 230 [V].

One reason for this is that, when the power source voltage is reduced, the heating amount decreases and the influence of undershooting becomes large, and consequently, it becomes necessary to increase the heating amount in consideration of the reduction. On the other hand, when the power source voltage is increased, the heating amount increases and the influence of overshooting becomes large, and consequently, it becomes necessary to reduce the heating amount in consideration of the increase.

In the case where the fixing temperature is different between the current job and the next job, the shifting amount is set as follows. The shifting amount is set to −5[%] when the temperature is smaller than the reference fixing temperature by 5[° C.] or more. The shifting amount is set to 0[%] when the temperature is within a range of −5[° C.] to 5[° C.] with respect to the fixing temperature. The shifting amount is set to 5[%] when the temperature is greater than the reference fixing temperature by 5[° C.] or more. One reason for this is that it is necessary to set the heating amount in accordance with the temperature in the next job.

Regarding the use history of upper fixing section 231, the initial state is set to 0[%], and the end state is set to 5[%]. One reason for this is that when upper fixing section 231 has been continuously used and the components have been degraded, the thermal conductivity from the inside to the surface is degraded, and it becomes necessary to increase the heating amount.

As shown in Table 4, the heating amount is set to a small value in the case where the basis weight of the sheet is small, and the heating amount is set to a large value in the case where the basis weight of the sheet is large. One reason for this is that the fixing temperature of a thick sheet is higher than the fixing temperature of a plain sheet, and the fixing temperature of a thin sheet is lower than the fixing temperature of a plain sheet.

It is to be noted that the values of the conditions for the evaluation may be changed in accordance with examples.

The embodiments disclosed herein are merely exemplifications and should not be considered as limitative. While the invention made by the present inventor has been specifically described based on the preferred embodiments, it is not intended to limit the present invention to the above-mentioned preferred embodiments but the present invention may be further modified within the scope and spirit of the invention defined by the appended claims.

The present invention is applicable to an image forming system composed of a plurality of units including an image forming apparatus. The units include, for example, a post-processing apparatus, an external apparatus such as a control apparatus connected with a network, and the like.

What is claimed is:

1. An image forming apparatus comprising:
a fixing member configured to fix an unfixed toner image formed on a sheet to the sheet at a fixing nip;
a heating section configured to heat the fixing member; and
a control section configured to control the heating section such that, when an operation state of the fixing member is transferred from a first operation state in which fixation is performed to a second operation state, the heating section heats the fixing member with a first heating amount during a period from a first timing at which the first operation state is started until a second timing which is a timing before the first operation state is completed, and the heating section heats the fixing member with a second heating amount smaller than the first heating amount and greater than 0 during a period from the second timing until a third timing at which the second operation state is started.

2. The image forming apparatus according to claim 1, wherein the control section changes a value of the second heating amount in accordance with the second operation state.

3. The image forming apparatus according to claim 1, wherein:
the control section determines whether there is a possibility of overshooting of a surface temperature of the fixing member after completion of the first operation state; and,
only when it is determined that there is a possibility of overshooting, the control section controls the heating section to heat the fixing member with the first heating amount during the period from the first timing until the second timing, and heat the fixing member with the second heating amount during the period from the second timing until the third timing.

4. The image forming apparatus according to claim 1, wherein the control section changes a value of the second heating amount in accordance with the second operation state and a voltage value of a power source used in the heating section.

5. The image forming apparatus according to claim 1, wherein the control section changes a value of the second heating amount in accordance with the second operation state and a temperature and a humidity around the image forming apparatus.

6. The image forming apparatus according to claim 1, wherein the control section changes the second heating amount in accordance with the second operation state and a type of the sheet.

7. The image forming apparatus according to claim 1, wherein the control section changes the second heating amount in accordance with the second operation state and a use history of the fixing member.

8. The image forming apparatus according to claim 1, wherein, when the second operation state is an operation state in which the fixation is performed, the control section determines the second heating amount such that fixation failure is not caused in the second operation state.

9. The image forming apparatus according to claim 1, wherein the control section controls a heating amount of the heating section based on an on-and-off pattern in a unit of half-wave of a predetermined duty ratio.

10. The image forming apparatus according to claim 1, wherein:
the heating section includes a plurality of heat generation members arranged at different positions in an axial direction of the fixing member; and
the control section selectively controls a heating amount of any of the heat generation members in accordance with a type of the sheet.

11. The image forming apparatus according to claim 1, wherein the second timing is a timing before a last sheet to be subjected to the fixation passes through the fixing nip.

12. The image forming apparatus according to claim 1, wherein the second timing is a timing at which a last sheet to be subjected to the fixation passes through the fixing nip.

13. An image formation system comprising:
a plurality of units including an image forming apparatus,
the image forming apparatus including:
a fixing member configured to fix an unfixed toner image formed on a sheet to the sheet at a fixing nip;
a heating section configured to heat the fixing member; and
a control section configured to control the heating section such that, when an operation state of the fixing member is transferred from a first operation state in which fixation is performed to a second operation state, the heating section heats the fixing member with a first heating amount during a period from a first timing at which the first operation state is started until a second timing which is a timing before the first operation state is completed, and the heating section heats the fixing member with a second heating amount smaller than the first heating amount and greater than 0 during a period from the second timing until a third timing at which the second operation state is started.

14. A method of controlling a heating amount of an image forming apparatus,
the image forming apparatus including:
a fixing member configured to fix an unfixed toner image formed on a sheet to the sheet at a fixing nip; and
a heating section configured to heat the fixing member,
the method comprising:
controlling the heating section such that, when an operation state of the fixing member is transferred from a first operation state in which fixation is performed to a second operation state, the heating section heats the fixing member with a first heating amount during a period from a first timing at which the first operation state is started until a second timing which is a timing before the first operation state is completed, and the heating section heats the fixing member with a second heating amount smaller than the first heating amount and greater than 0 during a period from the second timing until a third timing at which the second operation state is started.

15. The method according to claim 14, wherein a value of the second heating amount is changed in accordance with the second operation state.

16. The method according to claim 14, wherein:
whether there is a possibility of overshooting of a surface temperature of the fixing member after completion of the first operation state is determined; and,
only when it is determined that there is a possibility of overshooting, the heating section is controlled to heat the fixing member with the first heating amount during the period from the first timing until the second timing, and heat the fixing member with the second heating amount during the period from the second timing until the third timing.

17. The method according to claim 14, wherein a value of the second heating amount is changed in accordance with the second operation state and a voltage value of a power source used in the heating section.

18. The method according to claim 14, wherein a value of the second heating amount is changed in accordance with the second operation state and a temperature and a humidity around the image forming apparatus.

19. The method according to claim 14, wherein the second heating amount is changed in accordance with the second operation state and a type of the sheet.

20. The method according to claim 14, wherein the second heating amount is changed in accordance with the second operation state and a use history of the fixing member.
